(19) United States
(12) Patent Application Publication
(10) Pub. No.: US 2011/0147982 A1
(43) Pub. Date: Jun. 23, 2011

(54) GATE VALVE, FILM MANUFACTURING APPARATUS, AND FILM MANUFACTURING METHOD

(75) Inventors: Kazutoshi Nishio, Higashiyamato-shi (JP); Daisuke Aonuma, Kunitachi-shi (JP)

(73) Assignee: CANON ANELVA CORPORATION, Kawasaki-shi (JP)

(21) Appl. No.: 12/968,760

(22) Filed: Dec. 15, 2010

(30) Foreign Application Priority Data
Dec. 18, 2009 (JP) 2009-287238
Dec. 3, 2010 (JP) 2010-270748

(51) Int. Cl. B29D 7/01; F16K 3/00

(52) U.S. Cl. 264/165; 425/224; 251/329

(57) ABSTRACT

A film manufacturing apparatus includes a feed device, a take-up device, and a processing unit to perform a predetermined process for a film. The feed device, the take-up device, and the processing unit are arranged in vacuum chambers having opening portions through which a film can pass. Each opening portion includes a gate valve that can hermitically seal the vacuum chamber by sealing the film while clamping it. A recess portion is formed in the seal member of the valve body of each gate valve. The recess portion has a linear portion that is a size larger than the width of the film in a direction perpendicular to the transport direction of the film and the moving direction of the valve body.

### BACKGROUND OF THE INVENTION

1. Field of the Invention

The present invention relates to a gate valve, a film manufacturing apparatus including the gate valve, and a film manufacturing method using the film manufacturing apparatus and, more particularly, to a gate valve to be used for an apparatus which holds airtightness when transporting a film, for example, a film serving as the base material of a thin-film solar cell, electronic paper, an organic EL film substrate, or a continuous film to which a vacuum deposition method is applied, more specifically, a gate valve to hold airtightness while clamping a substrate film at its seal portion at the time of transporting the film, a film manufacturing apparatus including the gate valve, and a film manufacturing method using the film manufacturing apparatus.

2. Description of the Related Art

A film manufacturing apparatus includes a room to store a film feed roll (to be referred to as a “roll feed chamber” hereinafter), a room to store a film take-up roll (to be referred to as a “roll take-up chamber” hereinafter), and a transport path to make the two chambers communicate with each other. A film transport apparatus and a deposition chamber to perform a deposition process for a film are provided along the transport path.

Depending on the arrangements of a roll feed chamber and roll take-up chamber, one chamber serves as both a roll feed chamber and a roll take-up chamber as disclosed in, for example, Japanese Patent Laid-Open No. 2006-104494 (patent reference 1).

Among these film manufacturing apparatuses, the apparatus disclosed in Japanese Patent Laid-Open No. 2000-261015 (patent reference 2) includes intermediate chambers before and after a deposition chamber. This apparatus includes gate valves for partitioning between the deposition chamber and the intermediate chambers. Each gate valve closes while clamping a film at its seal portion to isolate all the deposition chambers constituting the film manufacturing apparatus.

In general, in a film manufacturing apparatus which includes a film roll feed chamber, a film roll take-up chamber, a transport path which makes the two chambers communicate with each other, and a deposition chamber and film transport apparatus which are arranged along the transport path, the operator performs replacement work for a feed roll or a take-up roll after restoring the overall apparatus to the atmospheric pressure.

This technique requires, for roll replacement, heating off, ventilation, roll replacement, evacuation, heating on, and starting production. For this reason, the one or two days are required for work time, resulting in a decrease in the operating rate of the apparatus. In addition, when trouble occurs in a given component of the film manufacturing apparatus, it is necessary to stop the overall apparatus. This leads to a decrease in the operating ratio of the apparatus.

In addition, there has been proposed a technique of providing gate valves to isolate the intermediate chambers and the deposition chamber in a film manufacturing apparatus and a technique of providing gate valves, each designed to clamp a seal portion of a film extending through it, between the roll feed chamber and the deposition chamber and between the deposition chamber and the roll take-up chamber. These techniques are not free from the possibility of a very small leak of air, and hence have difficulty in maintaining a vacuum state.

### SUMMARY OF THE INVENTION

The present invention provides a gate valve capable of holding airtightness while clamping a film, which can maintain a vacuum state by further reducing external leakage of air, quickly restore a roll feed chamber or a roll take-up chamber to the atmospheric pressure at the time of highly frequent roll replacement, and quickly return the chamber to a vacuum state after roll replacement.

In addition, the present invention provides a film manufacturing apparatus which can evacuate the respective chambers independently, control the ventilation of each chamber, and set a state in which the degree of vacuum in the deposition chamber does not decrease at the time of roll replacement and a state in which the degree of vacuum in the roll feed chamber and the roll take-up chamber does not decrease when the deposition chamber is restored to the atmospheric pressure, by incorporating such gate valves in the respective chambers, and a film manufacturing method using the film manufacturing apparatus.

According to one aspect of the present invention, there is provided a gate valve comprising:
a main body having internal space through which a member to be transported is configured to pass;
a valve body which blocks off the internal space in a closed state and releases the internal space in an open state;
a shaft which supports the valve body; and
a driving mechanism which raises the valve body through the shaft to block off the internal space and lowers the valve body through the shaft to release the internal space,
wherein a seal member which comes into contact with an upper inner surface of the main body, which is formed in the internal space, while the valve body is in an elevated state, is formed on the valve body, and
a recess portion is formed in the seal member, the recess portion having a linear portion with a size larger than a width of the member to be transported in a direction perpendicular to a transport direction of the member to be transported and a moving direction in which the valve body rises or lowers.

According to another aspect of the present invention, there is provided a film manufacturing apparatus which manufactures a film having a predetermined function by performing a process for a film, the apparatus comprising:
feed means for holding a film roll around which a long film is wound and feeding the film;
transport means for transporting the film fed by the feed means;
take-up means for taking up the film transported by the transport means; and
at least one processing means, disposed on a transport path between the feed means and the take-up means, for performing a predetermined process for the film,
wherein the feed means, the take-up means, and the processing means each are disposed in a vacuum chamber having an opening portion through which the film is configured to pass and include a gate valve, at the opening portion, which is configured to hermetically seal the vacuum chamber by sealing the film while clamping the film,
the gate valve comprises
a main body having internal space through which the film transported by the transport means is configured to pass,
a valve body which blocks off the internal space in a closed state and releases the internal space in an open state,
a shaft which supports the valve body, and
a driving mechanism which raises the valve body through the shaft to block off the internal space and lowers the valve body through the shaft to release the internal space,
a seal member which comes into contact with an upper inner surface of the main body, which is formed in the internal space, while the valve body is in an elevated state, is formed on the valve body, and
a recess portion is formed in the seal member, the recess portion having a linear portion with a size larger than a width of the member to be transported in a direction perpendicular to a transport direction of the member to be transported and a moving direction in which the valve body rises or lowers.

According to still another aspect of the present invention, there is provided a film manufacturing method of manufacturing a film having a predetermined function by performing a process for a film, the method comprising the steps of:
preparing the above-mentioned film manufacturing apparatus;
setting a film roll in the feed means and feeding a film;
performing the process for providing a predetermined function for the film upon raising a valve body of a gate valve of the film manufacturing apparatus in a vacuum chamber including the processing means, and hermetically sealing the vacuum chamber while clamping the fed film with a seal member formed on the valve body of the gate valve; and
causing the take-up means to take up the film for which the process has been performed,
wherein the film is clamped by the seal member in which a recess portion is formed, the recess portion having a linear portion with a size larger than a width of the film in a direction perpendicular to a transport direction of the film and a moving direction in which the valve body rises or lowers.

The present invention can maintain a vacuum state by further reducing leakage of air between the respective chambers while clamping a film. This makes it possible to quickly restore the roll feed chamber or the roll take-up chamber to the atmospheric pressure at the time of highly frequent roll replacement, quickly return the chamber to a vacuum state after roll replacement, and hold airtightness while clamping the film.

The present invention can control the ventilation of each chamber by incorporating such gate valves between the respective chambers and evacuating the respective chambers independently. This makes it possible to set a state in which the degree of vacuum in the deposition chamber does not decrease at the time of roll replacement and a state in which the degree of vacuum in the roll feed chamber and the roll take-up chamber does not decrease when the deposition chamber is restored to the atmospheric pressure.

Further features of the present invention will become apparent from the following description of exemplary embodiments with reference to the attached drawings.

### BRIEF DESCRIPTION OF THE DRAWINGS

FIG. 1 is a view showing the schematic arrangement of a film manufacturing apparatus according to an embodiment;

FIG. 2A is a view showing an example of an arrangement in which a seal member is disposed on the valve body of a gate valve according to this embodiment;

FIG. 2B is a view showing an example of an arrangement in which a seal member is also disposed on the main body side of a gate valve according to this embodiment;

FIG. 2C is a view showing a state in which the valve body of the gate valve according to this embodiment is closed;

FIG. 3 is a view showing the sectional arrangement of the gate valve when viewed from the front in the transport direction of a film;

FIG. 4A is an enlarged view of the seal member of the gate valve according to this embodiment;

FIG. 4B is an enlarged view showing an arrangement in which a seal member is disposed on the valve main body;

FIG. 5A is an enlarged view of the seal member of a gate valve according to another embodiment in an arrangement in which a valve body also has a recess portion;

FIG. 5B is an enlarged view showing an arrangement in which a seal member is disposed on the valve main body;

FIG. 6 is a schematic view of a film manufacturing apparatus according to another embodiment; and

FIG. 7 is a schematic view of a CIGS solar cell used for an explanation of a film manufacturing method according to another embodiment.

### DESCRIPTION OF THE EMBODIMENTS

The embodiments of the present invention will be described below with reference to the accompanying drawings. Note that members, arrangements, and the like to be described below provide an example of embodying the present invention, and do not limit the present invention. They can be variously modified within the spirit and scope of the present invention.

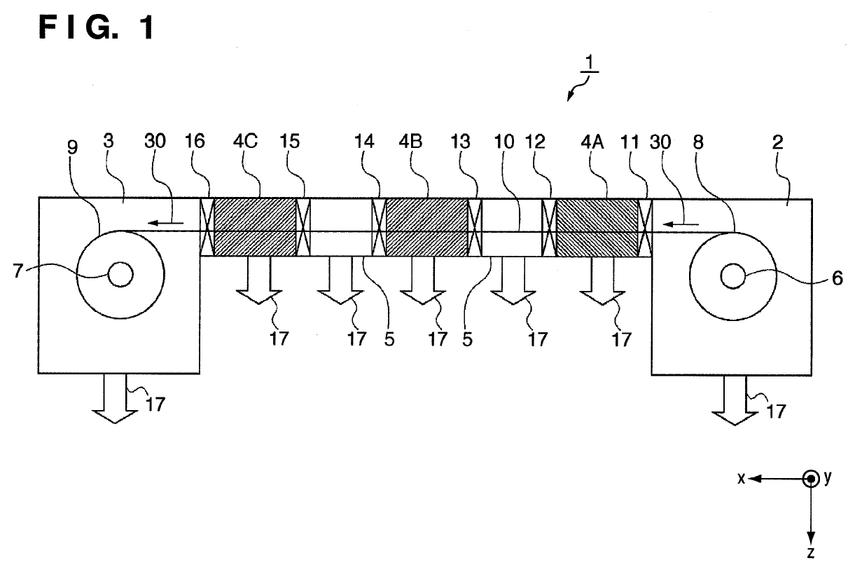

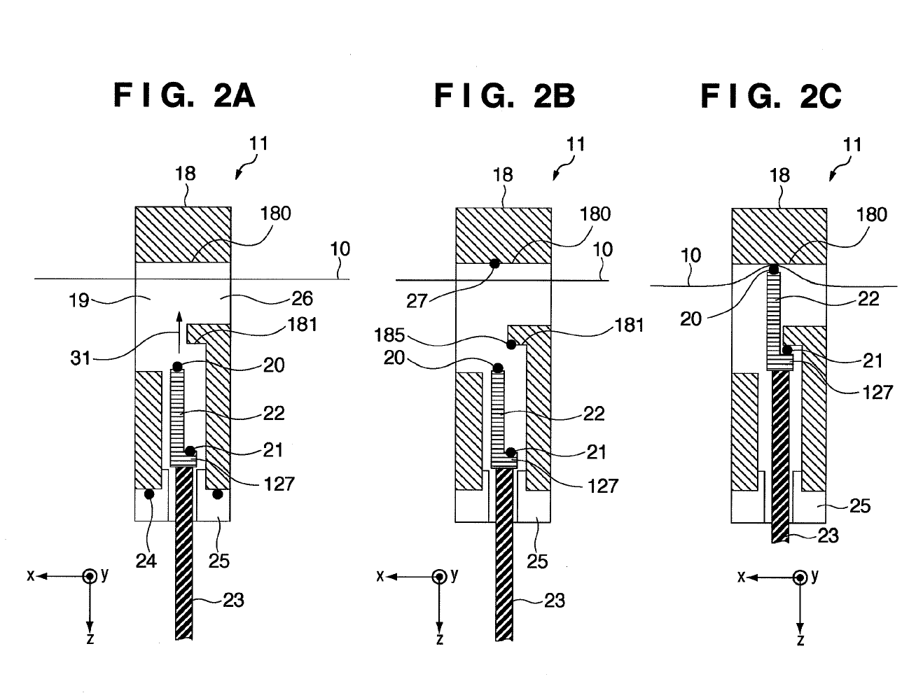

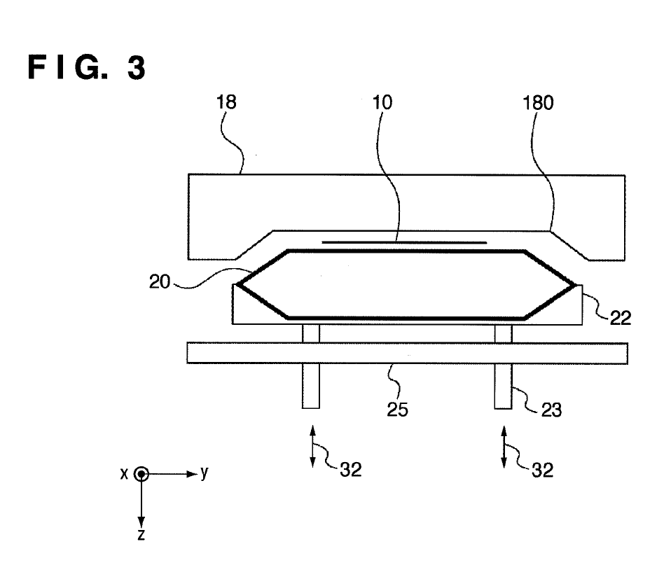

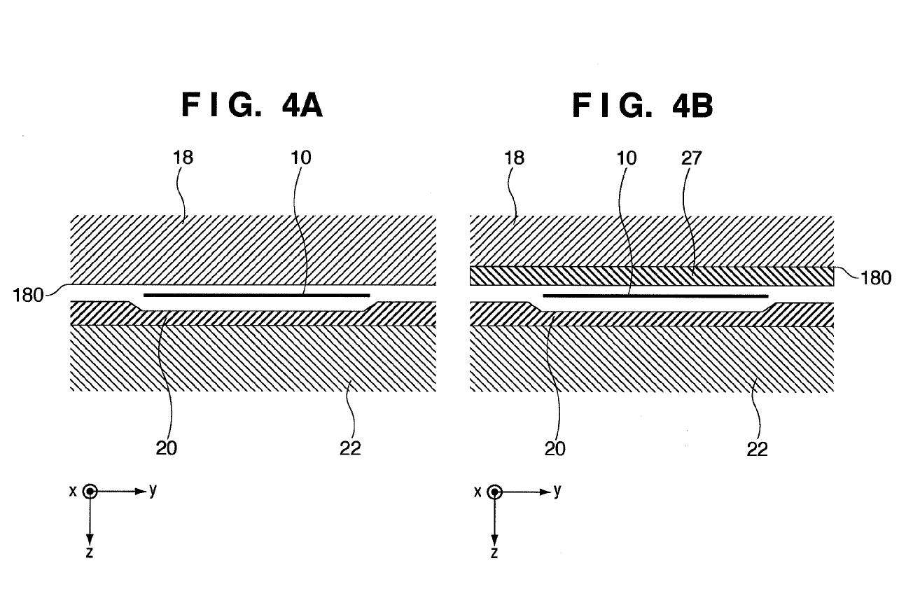

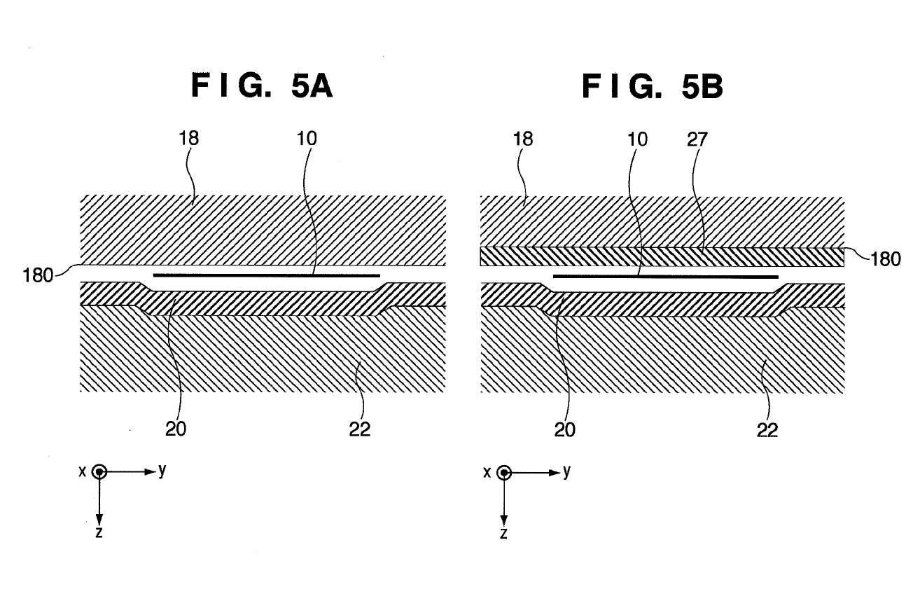

FIG. 1 shows an overall film manufacturing apparatus according to an embodiment of the present invention. FIGS. 2A to 2C and 3 are schematic views of a gate valve used in the film manufacturing apparatus according to the embodiment of the present invention. FIGS. 4A, 4B, 5A, and 5B are enlarged views showing the seal portion of the gate valve used in the film manufacturing apparatus according to the embodiment of the present invention.

The film manufacturing apparatus manufactures a film having a predetermined function by processing a film. Referring to FIG. 1, a film manufacturing apparatus 1 according to the embodiment of the present invention includes a roll feed chamber 2 as a chamber to store a feed roll 8, a roll take-up chamber 3 as a chamber to store a take-up roll 9, three reaction chambers 4A, 4B, and 4C (which are sometimes collectively referred to as a reaction chamber 4 hereinafter), and a film transport path 5 including a transport mechanism. The roll feed chamber 2 is provided with a roll feed device 6. The roll take-up chamber 3 is provided with a roll take-up device 7.

The film transport path 5 makes the roll feed chamber 2 communicate with the roll take-up chamber 3. This apparatus also includes at least one processing unit (reaction chamber 4) to perform a predetermined process (for example, a deposition process) to a film 10, which is provided on the transport path between the roll feed device 6 and the roll take-up device 7. The process to be performed in the reaction chamber 4 is not limited to a deposition process. The process to be performed in the reaction chamber 4 is not limited to a deposition process, and various kinds of vacuum processes can be adopted.

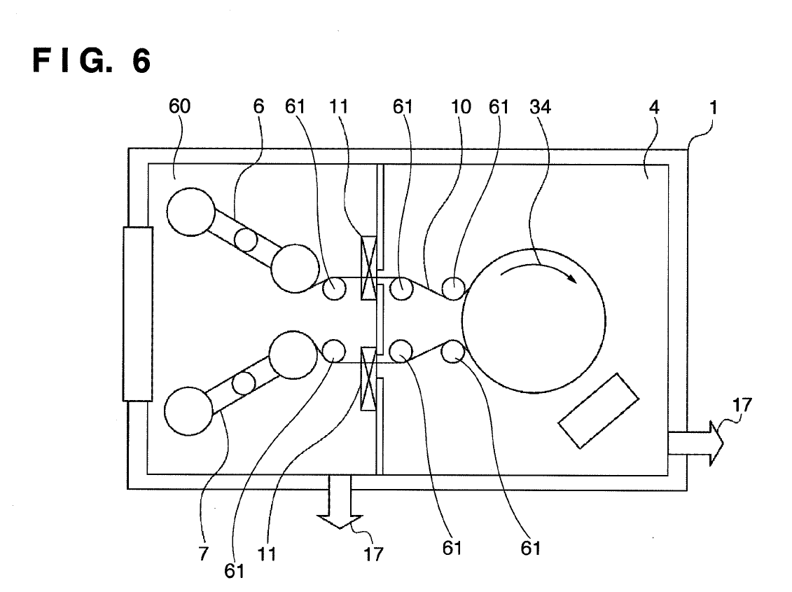

The roll feed device 6, the roll take-up device 7, and the processing units (reaction chambers 4) each are disposed in a vacuum chamber having opening portions through which a transported film can pass. Each opening portion has a gate valve which can hermetically seal the vacuum chamber while clamping the film 10. For example, gate valves 11, 12, 13, 14, 15, and 16 are provided on the film transport paths 5 before and after each reaction chamber 4. In the case shown in FIG. 1, this apparatus is configured to transport a film from the roll feed chamber 2 on the upstream side to the roll take-up chamber 3 on the downstream side (reference numeral 30 denotes the transport direction of the film 10). The arrangement of the apparatus is not limited to this. For example, like a film manufacturing apparatus according to another embodiment of the present invention shown in FIG. 6, this apparatus may be configured to provide the gate valve 11 between the reaction chamber 4 and a chamber 60 obtained by integrating the roll feed chamber 2 with the roll take-up chamber 3 (reference numeral 34 denotes the rotating direction of the roll). In the arrangement shown in FIG. 6, a transport mechanism 61 transports the film 10.

In the arrangement shown in FIG. 1, ventilation/evacuation units (vacuum pumps) 17 are respectively connected to the roll feed chamber 2, the roll take-up chamber 3, the reaction chamber 4, and the film transport paths 5. Deposition in the reaction chamber 4 and various kinds of processing mechanisms are known.

The roll feed device 6 holds the film roll (feed roll 8) around which a long film is wound, and can feed the film. The roll feed device 6 feeds the film 10 from the feed roll 8. The film 10 fed out by the roll feed device 6 passes through the gate valves 11, 12, 13, 14, 15, and 16, the reaction chambers 4A, 4B, and 4C, and the transport paths 5 and is taken up around the take-up roll 9 by the roll take-up device 7.

FIGS. 2A to 2C to 5A and 5B show the detailed arrangement of the gate valves 11, 12, 13, 14, 15, and 16 used in the film manufacturing apparatus according to the embodiment shown in FIG. 1. The gate valves 11, 12, 13, 14, 15, and 16 have the same arrangement. FIGS. 2A to 2C to 5A and 5B show one of them. The following will exemplify the gate valve 11.

The gate valve 11 includes a box-like valve main body 18 and a bottom plate 25 for maintenance. The gate valve 11 includes a packing 24 and the like between the respective components to prevent leakage. The valve main body 18 can be manufactured by, for example, joining the respective surfaces of the box-like body as plate-like discrete components to each other with screws and the like. The present invention imposes no limitation on a method of manufacturing the valve main body 18.

The box-like valve main body 18 has an internal space through which a member to be transported (film 10) can pass. The box-like valve main body 18 has internal spaces 19 and 26 as film passage windows (through holes) (FIG. 2A). A valve body 22 is disposed in the internal spaces 19 and 26 with a seal member 20 (first seal member). A driving mechanism (not shown) such as a cylinder can vertically move a shaft 23 which supports the valve body 22. The valve body 22 in a closed state blocks off the internal spaces 19 and 26. The valve body 22 in an open state releases the internal spaces 19 and 26. A driving mechanism (not shown) raises the valve body 22 through the shaft 23 to block off the internal spaces 19 and 26, and lowers the valve body 22 through the shaft 23 to release the internal spaces 19 and 26.

The seal member 20 (first seal member) is formed on the valve body 22. The seal member 20 comes into contact with the inner surface side of the valve main body 18 (to be referred to as a main body upper inner surface 180 hereinafter) as the valve body 22 rises. The seal member 20 (first seal member) has a recess portion conforming to the width of the member to be transported (film 10) in a widthwise direction perpendicular to the transport direction of the member to be transported (film 10) and the upward or downward moving direction of the valve body 22. The recess portion has a linear portion with a size larger than the width of the member to be transported (film 10). The depth of the recess portion is larger than the thickness of the film 10. The seal member 20 (first seal member) is provided on the upper end portion of the valve body 22. As the valve body 22 rises, the seal member 20 (first seal member) comes into contact with the main body upper inner surface 180. This blocks between the internal spaces 19 and 26.

The lower end portion of the valve body 22 has a stepped portion 127. The stepped portion 127 can be provided with a seal member 21. When the driving mechanism (not shown) raises the valve body 22, the seal member 20 (first seal member) of the valve body 22 comes into contact with the main body upper inner surface 180. The seal member 21 comes into contact with a stepped portion 181 formed on a side surface member of the valve main body 18 at the same time when the seal member 20 (first seal member) comes into contact with the main body upper inner surface 180. The contact of a plurality of seal members can further increase airtightness as they block between the internal spaces 19 and 26.

As the seal member 20 (first seal member) and the seal member 21, for example, FKM(VITON)® can be used. A material can be properly selected in consideration of the adhesiveness and hardness of the film 10 and the heat generated by thermal input in executing a process on the apparatus side. In place of the arrangement of the seal member shown in FIG. 2A, it is possible to use an arrangement in which a seal member 27 (second seal member) facing the seal member 20 is provided on the body upper inner surface 180 of the valve main body 18, as shown in FIG. 2B. In addition, a seal member 185 may be provided on the stepped portion 181 formed on the side surface member of the valve main body 18. As the seal member 27 (second seal member) and the seal member 185, for example, FKM(VITON)® can be used, like the seal member 20 (first seal member) and the seal member 21.

For example, as shown in FIG. 2A, when the arrangement provided with the seal members as shown in FIG. 2A blocks off the internal spaces 19 and 26, for example, the shaft 23 connected to the driving mechanism (not shown) is moved upward to clamp the film 10 between the first seal member 20 of the valve body 22 and the main body upper inner surface 180 serving as a seal surface, as shown in FIG. 2C. At the same time, the seal member 21 comes into contact with the stepped portion 181 formed on the side surface member of the valve main body 18 to block and seal between the internal spaces 19 and 26.

FIG. 3 shows the sectional arrangement of the gate valve 11 when viewed from the front in the transport direction of the film 10. The seal member 20 has a recess portion having a linear portion with a size longer than the width of a member to be transported (film 10) in the widthwise direction (y direction) perpendicular to the transport direction (x direction) of the film 10 and the moving direction (z direction) of the valve body 22. The depth of the recess portion is larger than the thickness of a member to be transported (film 10). The film 10 is clamped between the recess portion and the main body upper inner surface 180 (reference numeral 32 denotes the moving direction of the valve body 22). Assume that the sectional shape of the seal member 20 (first seal member) is configured such that the seal member has a recess portion having a linear portion with a size larger than the width of the film 10 in conformity with the film shape (the width of the film), as shown in FIG. 4A. In this case, the depth of the recess portion is larger than the thickness of the film 10. As shown in FIG. 4B, the seal member 27 (second seal member) having a constant thickness may be disposed on the upper inner surface 180 of the valve main body 18.

In addition, as shown in FIG. 5A, the valve body 22 is shaped to have a recess portion having a linear portion with a size longer than the width of the film 10 in conformity with the shape of the film 10 (the width of the film). In this case, the depth of the recess portion is larger than the thickness of the film 10. The seal member 20 (first seal member) may be formed in conformity with the recess portion. In this case, as shown in FIG. 5B, the seal member 27 (second seal member) having a uniform thickness may be further provided on the valve main body 18 side.

Letting the seal member 20 provided on the valve body 22 have a recess portion at a portion where the film 10 is clamped can reduce damages caused when the gate valve comes into contact with the film 10, such as a flaw made on the seal member by an end portion of the film 10 and a flaw made on the seal surface on the valve main body 18 side by the film 10.

In addition, it is possible to improve the sealing performance and vacuum holding ability by using the seal member 20 (first seal member) having a portion (recess portion) which is dented in conformity with the shape of the film 10 (the width and thickness of the film). Furthermore, using the seal member 27 (second seal member) on the upper inner surface 180 side of the valve main body 18 will reduce the possibility of damage to the film 10.

Referring to FIG. 1, as each of the gate valves 11, 12, 13, 14, 15, and 16, the gate valve shown in FIGS. 2A to 2C and 5A and 5B is used. A controller (not shown) which controls the overall operation of the film manufacturing apparatus can independently control the gate valves 11, 12, 13, 14, 15, and 16, and can also control the gate valves 11 and 12, the gate valves 13 and 14, and the gate valves 15 and 16 provided before and after the respective reaction chambers 4, respectively, in pairs.

When replacing the feed roll 8 of the roll feed device 6, the operator uses the gate valve 11. When replacing the take-up roll 9 of the roll take-up device 7, the operator uses the gate valve 16. When blocking each reaction chamber 4 from the remaining reaction chambers, the roll feed chamber 2, and the roll take-up chamber 3, the operator can use the gate valves 11 and 12, the gate valves 13 and 14, and the gate valves 15 and 16, in pairs.

In this arrangement, the ventilation/evacuation units 17 can independently perform vacuum processing for the roll feed chamber 2, the roll take-up chamber 3, and the reaction chamber 4.

According to this embodiment, it is possible to independently control the vacuum state or the like of each reaction chamber by incorporating gate valves. This allows to break the vacuum in only the roll feed chamber or the roll take-up chamber when replacing a roll. For example, it is possible to replace a roll in a short period of time by sequentially performing heating off, ventilation, roll replacement, evacuation, heating on, and starting production.

In addition, when some trouble occurs, it is only required to break the vacuum in only the corresponding vacuum chamber. Furthermore, clamping a film with a seal member will prolong the service life of the seal member. Forming a recess portion in the seal member in conformity with the shape of a film (the width and thickness of the film) can improve the sealing performance by blocking between the internal spaces 19 and 26.

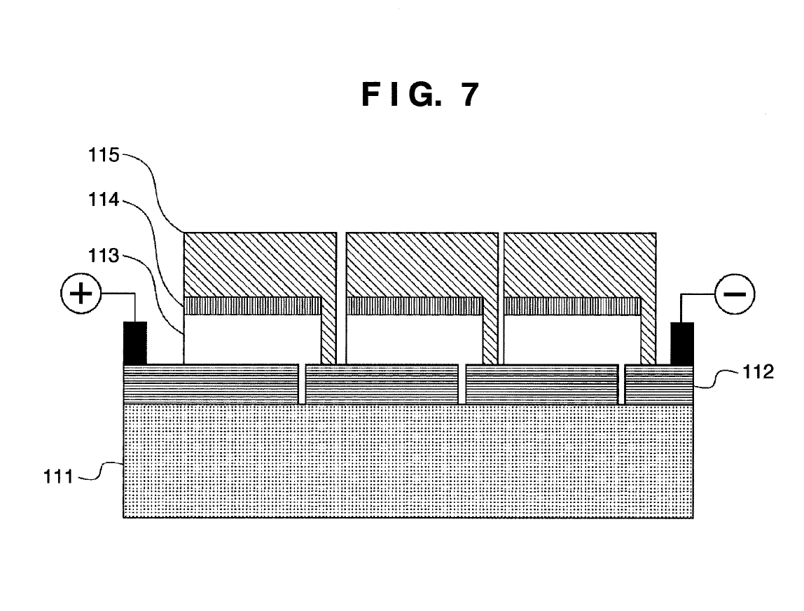

A film manufacturing method manufactures a film having a predetermined function by performing a process for a film. The method includes a step of preparing a film manufacturing apparatus as described above. The method includes a step of setting a film roll in the feed means and feeding a film. The method includes a step of performing the process for providing a predetermined function for the film upon raising a valve body of a gate valve of the film manufacturing apparatus in a vacuum chamber including the processing means, and hermetically sealing the vacuum chamber while clamping the fed film with a seal member formed on the valve body of the gate valve. The method includes a step of causing the take-up means to take up the film for which the process has been performed. The film is clamped by the seal member in which a recess portion is formed, the recess portion having a linear portion with a size larger than a width of the film in a direction perpendicular to a transport direction of the film and a moving direction in which the valve body rises or lowers. FIG. 7 is a schematic sectional view of a typical Cu—In—Ga—Se (to be referred to as CIGS hereinafter) compound solar cell. Reference numeral 111 denotes a resin member as a substrate or a film as of a stainless steel or aluminum film; 112, an Mo layer as a lower-surface electrode; 113, a CIGS compound layer as an electrogenic portion; 114, a buffer layer made of, for example, CdS; and 115, an AZO layer as a window layer.

An example of a film manufacturing method using a film manufacturing apparatus according to the present invention will be described in association with this solar cell. A light absorption layer is formed after the Mo layer 112 as a lower electrode is deposited on the film 111 by a sputtering method.. The CIGS compound layer 113 as a light absorption layer is a polycrystalline compound obtained by, for example, annealing the multilayer structure obtained by stacking two layers including a CuGa alloy layer and an In layer in an H₂Se atmosphere at a high temperature. A CdS layer as the buffer layer 114 is deposited by, for example, a chemical bath deposition method.

Finally, the AZO layer 115 as a window layer is deposited by a sputtering method.

Assume that this method is applied to the step of depositing a film by the sputtering method. In this case, it is possible to form a double-layer film of ZnO+AZO or the like in place of the single-layer of AZO as a window layer.

In this case, it is possible to manufacture such films by disposing two reaction chambers in the film manufacturing apparatus shown in FIG. 1. It is preferable to use, for example, a ZnO layer sputtering chamber as the reaction chamber 4A and an AZO layer sputtering chamber as the reaction chamber 4B in FIG. 1. It is also possible to deposit the Mo layer 112 as a lower electrode by using the film manufacturing apparatus shown in FIG. 1. It is preferable to use, for example, an underlying Ti deposition chamber, a first Mo layer deposition chamber, and a second Mo layer deposition chamber as the reaction chambers 4A, 4B, and 4C, respectively.

Assume that a sputtering apparatus is to be used, and the feed roll is to be replaced. In this case, the operator replaces the roll by using the gate valves according to the embodiment of the present invention, without ventilating the entire apparatus, according to the following procedure: hermetically sealing a film extending through the gate valve, ventilating only the roll feed chamber, replacing the roll feed device 6, and connecting the new roll to the film extending through the gate valve.

Likewise, the operator replaces the take-up roll 9 by using the gate valves according to the embodiment of the present invention according to the following procedure: hermetically sealing a film extending through the gate valve, ventilating only the roll take-up chamber, replacing the take-up roll 9, and connecting the new roll to the film extending through the gate valve.

In this manner, it is possible to replace a roll without releasing the reaction chambers (deposition chambers) to the atmosphere. This can minimize leakage from a hermetically sealed film portion, and hence can prevent contamination in the reaction chambers while securing a high yield.

As an embodiment of the present invention, the gate valves and the film manufacturing apparatus can be applied to the process of producing an image display apparatus having a large display area by, for example, performing a deposition process for a long member to be transported while the member is transported between the roll feed device 6 and the roll take-up device 7, in addition to the above techniques. Image display apparatuses having large display areas include, for example, a liquid crystal display using a film base material, organic luminescence display (organic EL display), and touch panel. The system to be used for each reaction chamber is not limited to the above deposition apparatus (sputtering apparatus). For example, a PE-CVD apparatus, plasma etching apparatus, and the like can be used as long as they are vacuum processing apparatuses.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-287238 filed Dec. 18, 2009 and Japanese Patent Application No. 2010-270748 filed Dec. 3, 2010, which are hereby incorporated by reference herein in their entirety.

What is claimed is:

1. A gate valve comprising:
a main body having internal space through which a member to be transported is configured to pass;
a valve body which blocks off the internal space in a closed state and releases the internal space in an open state;
a shaft which supports said valve body; and
a driving mechanism which raises said valve body through said shaft to block off the internal space and lowers said valve body through said shaft to release the internal space,
wherein a seal member which comes into contact with an upper inner surface of said main body, which is formed in the internal space, while said valve body is in an elevated state, is formed on said valve body, and
a recess portion is formed in the seal member, the recess portion having a linear portion with a size larger than a width of the member to be transported in a direction perpendicular to a transport direction of the member to be transported and a moving direction in which said valve body rises or lowers.

2. The valve according to claim 1, wherein a second seal member facing the seal member is provided on the upper inner surface of said main body.

3. The valve according to claim 1, wherein a depth of the recess portion is larger than a thickness of the member to be transported.

4. A film manufacturing apparatus which manufactures a film having a predetermined function by performing a process for a film, the apparatus comprising:
feed means for holding a film roll around which a long film is wound and feeding the film;
transport means for transporting the film fed by said feed means;
take-up means for taking up the film transported by said transport means; and
at least one processing means, disposed on a transport path between said feed means and said take-up means, for performing a predetermined process for the film,
wherein said feed means, said take-up means, and said processing means each are disposed in a vacuum chamber having an opening portion through which the film is configured to pass and include a gate valve, at the opening portion, which is configured to hermetically seal the vacuum chamber by sealing the film while clamping the film,
said gate valve comprises
a main body having internal space through which the film transported by said transport means is configured to pass,
a valve body which blocks off the internal space in a closed state and releases the internal space in an open state,
a shaft which supports said valve body, and
a driving mechanism which raises said valve body through said shaft to block off the internal space and lowers said valve body through said shaft to release the internal space,
a seal member which comes into contact with an upper inner surface of said main body, which is formed in the internal space, while said valve body is in an elevated state, is formed on said valve body, and
a recess portion is formed in the seal member, the recess portion having a linear portion with a size larger than a width of the member to be transported in a direction perpendicular to a transport direction of the member to be transported and a moving direction in which said valve body rises or lowers.

5. The apparatus according to claim 4, wherein a second seal member facing the seal member is provided on the upper inner surface of said main body of said gate valve.

6. The apparatus according to claim 4, wherein a depth of the recess portion has a size larger than a thickness of the member to be transported.

7. A film manufacturing method of manufacturing a film having a predetermined function by performing a process for a film, the method comprising the steps of:
preparing a film manufacturing apparatus defined in claim 4;
setting a film roll in the feed means and feeding a film;
performing the process for providing a predetermined function for the film upon raising a valve body of a gate valve of the film manufacturing apparatus in a vacuum chamber including the processing means, and hermetically sealing the vacuum chamber while clamping the fed film with a seal member formed on the valve body of the gate valve; and
causing the take-up means to take up the film for which the process has been performed,
wherein the film is clamped by the seal member in which a recess portion is formed, the recess portion having a linear portion with a size larger than a width of the film in a direction perpendicular to a transport direction of the film and a moving direction in which the valve body rises or lowers.

8. The method according to claim 7, wherein a second seal member facing the seal member is provided on the upper inner surface of the main body of the gate valve of the film manufacturing apparatus, and the film is clamped by the seal member and the second seal member which are formed on the valve body.

9. The method according to claim 7, wherein a depth of the recess portion is larger than a thickness of the film.
